(19) United States
(12) Patent Application Publication
(10) Pub. No.: US 2024/0103874 A1
(43) Pub. Date: Mar. 28, 2024

(54) INSTRUCTION ELIMINATION THROUGH HARDWARE DRIVEN MEMOIZATION OF LOOP INSTANCES

(71) Applicant: Intel Corporation, Santa Clara, CA (US)

(72) Inventors: Niranjan Kumar Soundararajan, Bengaluru (IN); Sreenivas Subramoney, Bangalore (IN); Jayesh Gaur, Bangalore (IN)

(21) Appl. No.: 17/951,859

(22) Filed: Sep. 23, 2022

(51) Int. Cl. G06F 9/38; G06F 9/30; G06F 9/32

(52) U.S. Cl. CPC G06F 9/381; G06F 9/30065; G06F 9/325

(57) ABSTRACT

Methods and apparatus for instruction elimination through hardware driven memoization of loop instances. A hardware-based loop memoization technique learns repeating sequences of loops and transparently removes instructions for the loop instructions from instruction sequences while making their output available to dependent instructions as if the loop instructions had been executed. A path-based predictor is implemented at the front-end to predict these loop instances and remove their instructions from instruction sequences. A novel memoization prediction micro-operation (Uop) is inserted into the instruction sequence for instances of loops that are predicted to be memoized. The memoization prediction Uop is used to compare the input signature (expected set of input values for the loop) with the actual signature to determine correct and incorrect predictions. The input signature learnt is based on all live-ins of a loop, both explicit register-based live-ins as well as loads to memory in the loop body that determine code path and outputs.

### BACKGROUND INFORMATION

Loops are a very common programming construct used in applications to accomplish tasks that require repeating a sequence of tasks on different sets of input data. Oftentimes, due to lack of data entropy, the input data that is accessed by a loop remains the same, which results in execution of the loop instructions providing the same set of output data. Thus, under such conditions the execution of the loop instructions is wasteful and reduces overall throughput.

Generally, memoization is a technique of saving the results of instruction execution so that future execution of the instructions can be omitted under applicable conditions, such as when the input data for the instruction execution is the same. There have been attempts to memoize loops using software. However, the software techniques are conservative, require additional overhead, and miss out on significant performance opportunity. Previous approaches to memoize loops in hardware have likewise produced limited benefit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating a high-level overview of the microarchitecture for loop memoization in hardware, according to one embodiment;

FIG. 2 is a process flow diagram illustrating operations and associated hardware for enabling memoization of loop bodies in hardware, according to one embodiment;

FIG. 3 is a diagram illustrating an out-of-order core pipeline and highlighting the different stages where each of the operations in FIG. 2 get accomplished;

FIG. 4 is a diagram illustrating the format of entries in a loop memoization table, according to one embodiment;

FIG. 5 is a diagram illustrating the format of entries in a memoization predictor table, according to one embodiment

FIG. 6 is a flowchart illustrating operations performed by a path-based memoization predictor and a memoize predictor Uop, according to one embodiment;

FIG. 7 illustrates an example computing system;

FIG. 8 illustrates a block diagram of an example processor and/or System on a Chip (SoC) that may have one or more cores and an integrated memory controller;

FIG. 9(A) is a block diagram illustrating both an example in-order pipeline and an example register renaming, out-of-order issue/execution pipeline according to examples;

FIG. 9(B) is a block diagram illustrating both an example in-order architecture core and an example register renaming, out-of-order issue/execution architecture core to be included in a processor according to examples;

FIG. 10 illustrates examples of execution unit(s) circuitry; and

FIG. 11 is a block diagram of a register architecture according to some examples.

### DETAILED DESCRIPTION

Embodiments of methods and apparatus for instruction elimination through hardware driven memoization of loop instances are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the FIG.s herein may also be referred to by their labels in the FIG.s, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing FIG.s for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments described and illustrated herein, a hardware-based loop memoization technique is provided that learns repeating sequences of loop instances and transparently removes instructions for these loop sequences from the instruction pipeline while making their output available to dependent instructions as if the instructions had been executed. To eliminate full sequences loops instructions, we integrate a path-based predictor at the front-end to predict instances of memoized loops and remove their loop instructions from the pipeline. A novel memoization prediction micro-operation (Uop) is inserted into the pipeline for instances of loops that are predicted to be memoized and is used to compare the input signature (expected set of input values for the loop) with the actual signature to determine whether the prediction is correct or not. For incorrect predictions the pipeline is quickly flushed and restarted. The input signature learnt is based on all live-ins of a loop, both explicit register-based live-ins as well as loads to memory in the loop body that determine code path and outputs.

In another aspect, a memoization table is used to capture the loop's input and output data (live-ins and live-outs) that are learnt. The memoized loop's fetch/decode/execute/retire operations through the pipeline can be eliminated while providing their output values from the table quickly for the post-loop instruction stream, resulting in both performance and power gains. This memoization is done in hardware which enables the loop sequences to be detected based on dynamic instruction flow to get the maximum benefit while also be transparent to the software running on the platform, thus requiring not changes to existing or future software.

Identifying these often-repeating loops and their often-repeating input/output signatures and eliminating them from the instruction pipeline has tremendous potential but comes with significant challenges related to training quickly, capturing the loop information succinctly in a table, quickly flushing and restarting pipeline on a misprediction and providing the dependent instructions with data at the earliest for maximum performance gains. The embodiments address these challenges and provide detailed microarchitecture definitions required to memoize loops. This technique works transparently for any application and does not require any compiler support or ISA (Instruction Set Architecture) addition.

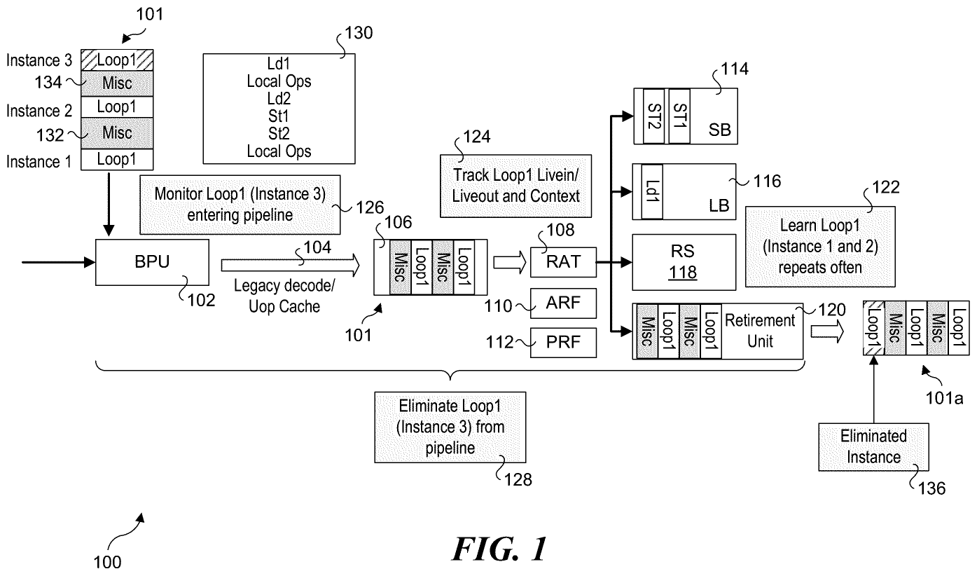

Diagram 100 in FIG. 1 provides a high-level overview of the microarchitecture for loop memoization in hardware, according to one embodiment. For simplicity, the incoming sequence of instructions are broken into parts highlighting the repeating instances of the loop (loop1) that does the same work across different calls. At retirement, loop1 is identified, the context (live-ins and live-outs along with the program path) is monitored and once this loop is seen sufficient times, it is eliminated from the pipeline and only the output values are made available, much earlier than otherwise, to the dependent instructions.

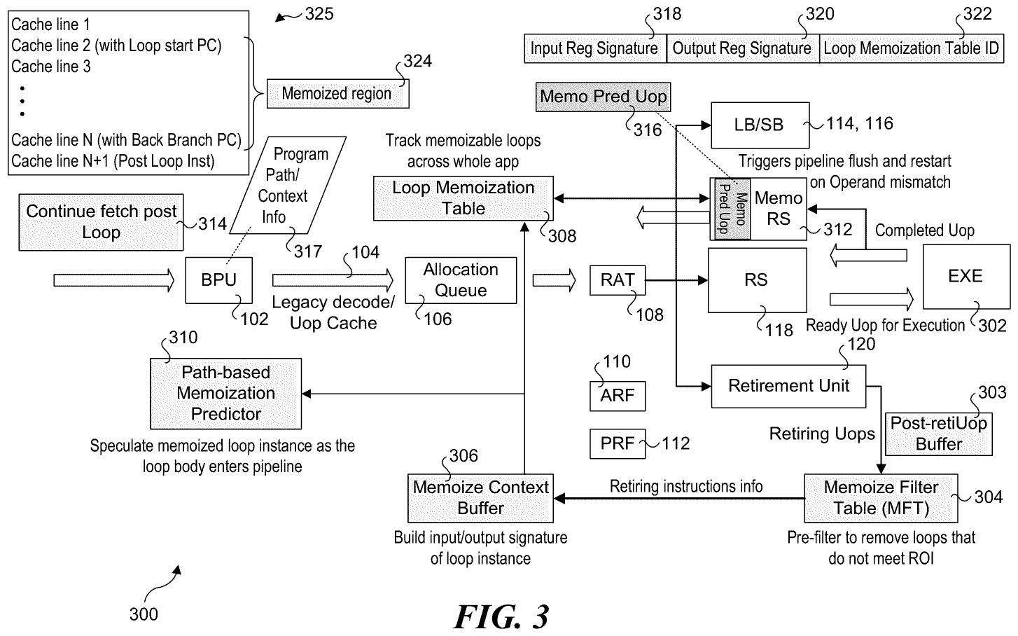

Diagram 100 shows a process flow for an instruction thread 101 and selected microarchitecture components and logic used to process instructions in instruction thread 101 as they proceed through a processing pipeline. Component with a white background represent conventional components, while components and logic blocks with a gray background are new. The conventional microarchitecture components include a branch prediction unit (BPU) 102, a legacy decode/Uop cache 104, an allocation queue 106, a Register Alias Table (RAT) 108, an Architectural Register File (ARF 110), a Physical Register File (PRF) 112, a Store Buffer (SB) 114, a Load Buffer (LB) 116, a Reservation Station (RS) 118, and a retirement unit 120. A reservation unit, such as RS 118, queues up Uops until all source operands are ready, and schedules and dispatches ready Uops to available execution units, as exemplified by an execution unit 302 in FIG. 3. The microarchitecture logic shown in logic blocks 122, 124, 126, and 128 is new.

Instruction thread 101 includes three instances of a loop 130 interspersed between miscellaneous instruction sequences 132 and 134. In this simplified example, loop 130 includes the following sequence of instructions: Ld1 (Load 1); Local Ops; Ld2; St1 (Store1) St2; and Local Ops. Generally, the sequences of instruction for a loop and miscellaneous instruction sequences 132 and 134 may vary in length. In addition, in an actual implementation there may be one or more instances of other loops that may or may not be repeated.

Instructions in instruction thread 101 are received at BPU 102, which performs branch prediction operations (e.g., “predict” the outcome and target of a branch instruction branch). The instructions in instruction thread 101 are cached in legacy decode/Uop cache 104, and subsequently loaded into allocation queue 106. Allocation queue may also be referred to as an instruction decoder queue (IDQ) under some CPU architectures.

Instructions in allocation queue 106 are then loaded for execution by an execution unit (not shown) using RAT 108, ARF 110, PRF 112, SB 114, LB 116, and RS 118. RAT 108 contains entries mapping logical operand values to physical operand values. ARF 110 contains architectural registers and PRF 112 contains physical registers. As shown, store instructions St1 and St2 are loaded into SB 114, while load instruction Ld1 has been loaded into LB 116. Following execution, the instruction in the first and second instances of Loop 1 and miscellaneous instruction sequences 132 and 134 will be loaded into retirement unit 120.

The new logic in logic blocks 122, 124, 126 and 128 operate as follows. Logic block 122 is configured to detect repeated instruction sequences and learns the instruction sequence 130 corresponding to Loop 1 is repeated multiple times. Logic block 124 tracks Loop 1's input and output data (Live-in and Live-out) and its context. Logic block 126 monitors for instances of Loop1 (Instance 3 in this example) entering the front-end pipeline. Logic block 128 eliminates Instance 3 of Loop 1 from the pipeline. As shown in the sequence of retired instructions 101a output by retirement unit 120 the third instance of Loop 1 (eliminated instance 136) has been eliminated.

Microarchitectural Changes to Enable Hardware-Based Loop Memoization

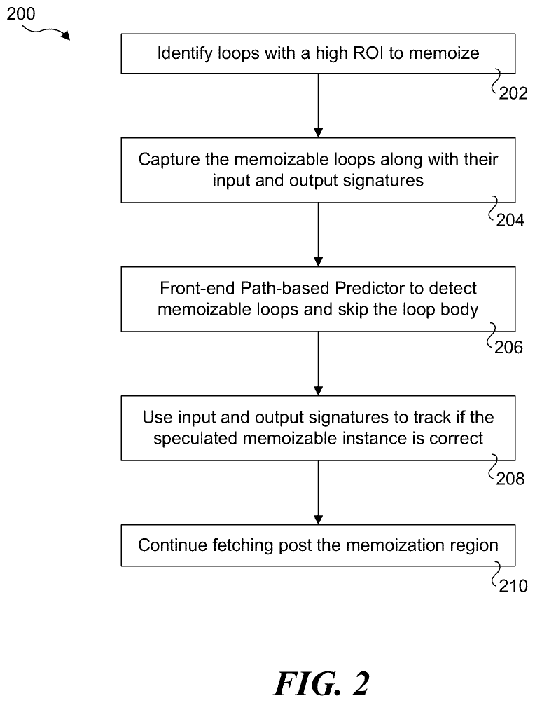

FIG. 2 shows a process flow diagram 200 illustrating operations and associated hardware for enabling memoization of loop bodies in hardware. In a block 202, loops with a high return in investment (ROI) to memoize are identified. For example, loops that are very small and/or infrequently repeated may not be good candidates for memoization, while loops of moderate length or larger may save more CPU cycles if memoized. Next, a block 204 is used to capture memoizable loops along with their input and output signatures. Savings from memoization require two criteria. First, the instruction sequence needs to be the same. Second, the data being operated on by the loop instructions must be the same, otherwise the output data produced via execution of the loop instructions will differ. As described and illustrated in further detail below, the input and output signatures are used to verify a speculated memoizable loop instance is correct.

As shown in a block 206, front-end path-based predictor logic is provided to detect memoizable loops and skip the loop body. In a block 208, the input and output signatures of the memoizable loops that are captured in block 204 are used to track if a speculated memoizable instance is correct. As shown in a block 210, the hardware logic is configured to continue fetching instructions after the memoization region.

Diagram 300 in FIG. 3 lays out an out-of-order core pipeline and highlights the different stages where each of the operations in FIG. 2 get accomplished. Blocks with like reference numbers in FIGS. 1 and 3 depict the same components. In addition to the conventional hardware components shown in FIG. 1, diagram 300 further includes an execution unit 302, which is representative of various types of execution units. New components, data structures, and logic in diagram 300 include a post-retiUop buffer 303, a memo filter table (MFT) 304, a memoize context buffer (MCB) 306, a loop memoization table 308, a path-based memoization predictor 310, a memo reservation station 312, and a continue fetch post loop block 314. Path-based memoization predictor 310 uses program path/context information 317 that is maintained by BPU 102.

The input to the pipeline includes a memoized region 324 in a sequence of cache lines that have been loaded into a front-end instruction buffer 325. As illustrated, memoized region 324 begins with a cache line (2) that includes a loop start program counter (PC) and ends with a cache line (N) with a back branch PC.

To detect the loops that are memoizable, the Uops retiring in each cycle are captured in post-retiUop buffer 303. In one embodiment, this Uop buffer is sized at twice the retirement width to avoid stalling the retirement stage and to avoid dropping Uops as they retire. From the post-retiUop buffer 303, MFT 304 monitors for back-branch PCs and their targets to identify instances of loops, and keeps occurrence counts of the identified loops. MCB 306 tracks the different input and output values through registers and loads/stores and the order in which they occur. The ordering is important to preserve correctness. These together form the input and output signature of the loop for each particular instance learnt in the MCB. MFT 304 also identifies loops that are not suitable for memoization and should be ignored. For example, such loops may be too long and/or having too many loads and/or stores. For such loops MFT 304 informs MFT 304 these loops are ignored so that MFT 304 will discontinue updating occurrence counts for these loops.

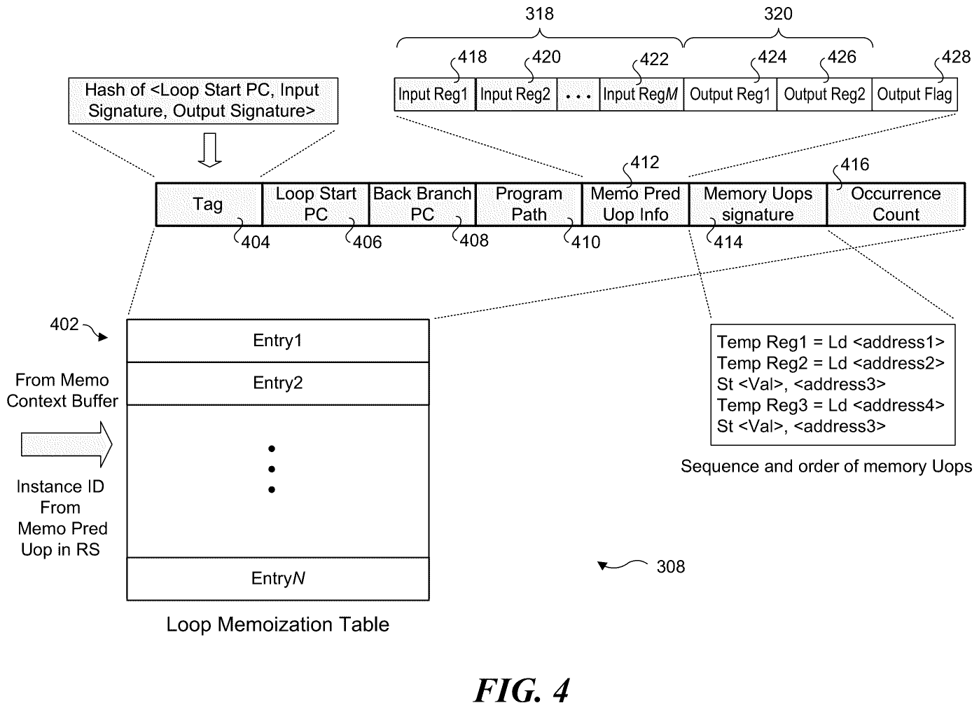

Once we detect back-branches and their targets, MFT 304 is checked to identify whether any loops are sufficiently recurring to be tracked and have not been ignored. These loops are candidates for memoization. Accordingly, a new memoization entry is added to memoization table 308, as described below with reference to FIG. 4. If there is an already existing entry, the confidence and occurrence counters are updated.

FIG. 4 shows loop memoization table 308, according to one embodiment. The loop memoization table includes multiple entries 402. Each entry 402 includes a tag 404, a loop start PC 406, a back branch PC 408, a program path 410, memo prediction Uop information 412, a memory Uops signature 414, and an occurrence count 416. In the illustrated embodiment, tag 404 comprises a hash of <loop start PC 406, an input signature, and an output signature>. Memo prediction Uop information 412 includes multiple (e.g., M) input registers, depicted as input registers 418, 420 . . . 422 (Input Reg1, Input Reg2 . . . Input RegM), a first output register 424, a second output register 426, and an output flag 428.

Memory Uops signature 414 contains a specific sequence of memory Uops, as they occur in the original loop code, for memoized loop. As shown in this abstracted example, the sequence of memory Uops includes the following:
Temp Reg 1=Ld<address1>; Load memory address 1 into temporary register 1
Temp Reg 2=Ld<address2>; Load memory address 2 into temporary register 2
St<Val>, <address 3>; Store value Val at memory address 3
Temp Reg 3=Ld<address4>; Load memory address 4 into temporary register 3
St<Val>, <address 5>; Store value Val at memory address 5
   As shown in FIG. 4, some of the information for entries 402 is obtained from memo context buffer 306, while a loop instance identifier (ID) used to identify loop memoization table entries is provided by the memoization predictor (Memo Pred) Uop described below.

Each entry 402 has an associated entry identifier (ID). The entry ID may be inherent based on the order of the entry in loop memoization table 308, or an explicit entry ID field may be included (not shown in FIG. 4).

To lower the pipeline resource utilization, as soon as the loop region enters the pipeline in the front-end, a program path-based memoization predictor (310) is incorporated to detect if a particular instance of the loop can be eliminated from the pipeline. Path-based memoization predictor 310 uses program path/context information 317 to identify program paths associated with a given start loop PC (e.g., the program path when a start loop PC is encountered in the instruction pipeline entering BPU 102). Generally, a BPU will use one or more algorithms to predict branch operations. In connection with the branch prediction algorithm(s), the BPU will maintain program path/context information, which is used by the algorithm(s) to predict branches to be taken. The program path/context information helps identify if a particular loop instance is for a loop that has been memoized and therefore can be eliminated confidently from the pipeline. A highly accurate predictor eliminates most recurring loop instances while avoiding unnecessary mispredictions that results in a performance penalty.

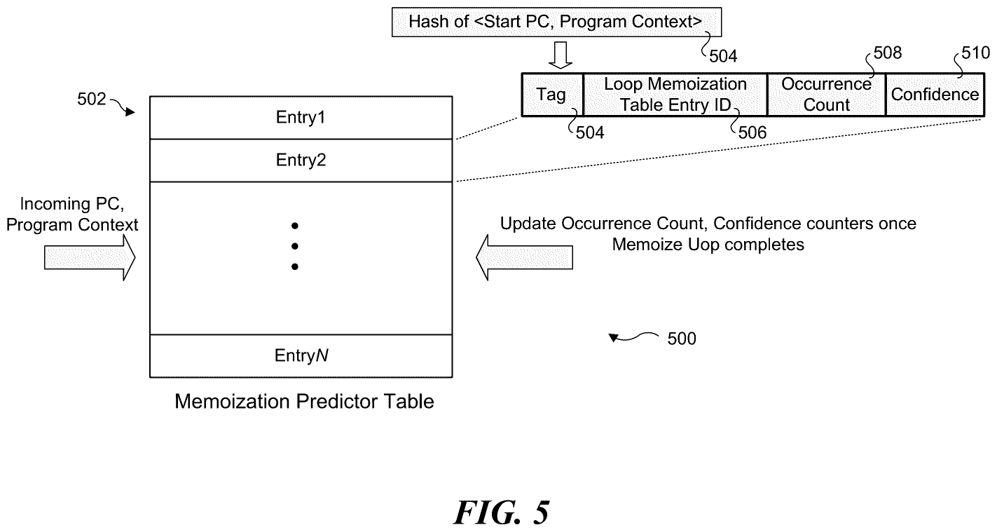

FIG. 5 summarizes the fields in a memoization predictor table 500 maintained by path-based memoization predictor 310, according to one embodiment. Memoization predictor table 500 includes multiple entries 502, which are associated with corresponding entries 402 in loop memoization table 308. Each entry 502 includes a tag 504, a memoization table loop entry ID 506, an occurrence count 508, and a confidence counter 510. In the illustrated embodiment, tag 504 comprises a hash of the start (loop) PC and the program context obtained from program path/context information 317. Upon completion of the memoize predictor Uop, occurrence count 508 and confidence counter 510 are updated.

Detect Mispredictions Early and Triggering Resteering

Given that the path-based predictor in the front-end speculates whether the incoming loop body corresponds to a loop that has been memoized, we track and to make sure the input signature of the loop body matches with the specific instance picked by the front-end predictor. Towards this, an artificial memoize predictor Uop (316) is inserted into the instruction pipeline that tracks the input signature corresponding to the instance identified by the front-end predictor. In one embodiment, memoize predictor Uop 316 is inserted into the instruction pipeline at allocation queue 106. As describe below, memoize predictor Uop 316 is transparent to conventional execution units and passes through without being executed.

Execution memoize predictor Uop 316 is used to verify whether the input values loaded into the input registers in preparation for execution of the first loop instruction match the input signature value for the predicted loop instance. Once all the input values arrive and match the values in the predicted instance, memoize predictor Uop 316 is removed from the pipeline. In case the input values differ from the predicted instance, then the memoize predictor Uop 316 triggers a pipeline flush and to restart execution from the first instruction of the loop body.

While we memoize and coalesce the loop body into the memoize predictor Uop, the loads and all store instructions go through the pipeline as is. For stack-based loads, the stack pointer register (RSP) offsets need to be adjusted to fetch from the right location. The loads help identify if some of the memory values have changed between different instances of the loop and therefore cannot be eliminated from execution. The stores go through the pipeline for correctness.

Continuing Fetch Post the Memoization Region

Besides eliminating the loop body, one of the biggest reasons for the performance gain comes from enabling all the instructions that are dependent on the memoized loop body to start their execution earlier than otherwise. To enable this, we insert temporary move Uops dynamically to allow RAT 108 to rename the output registers in the memoizable region for the later instructions to progress faster with their execution.

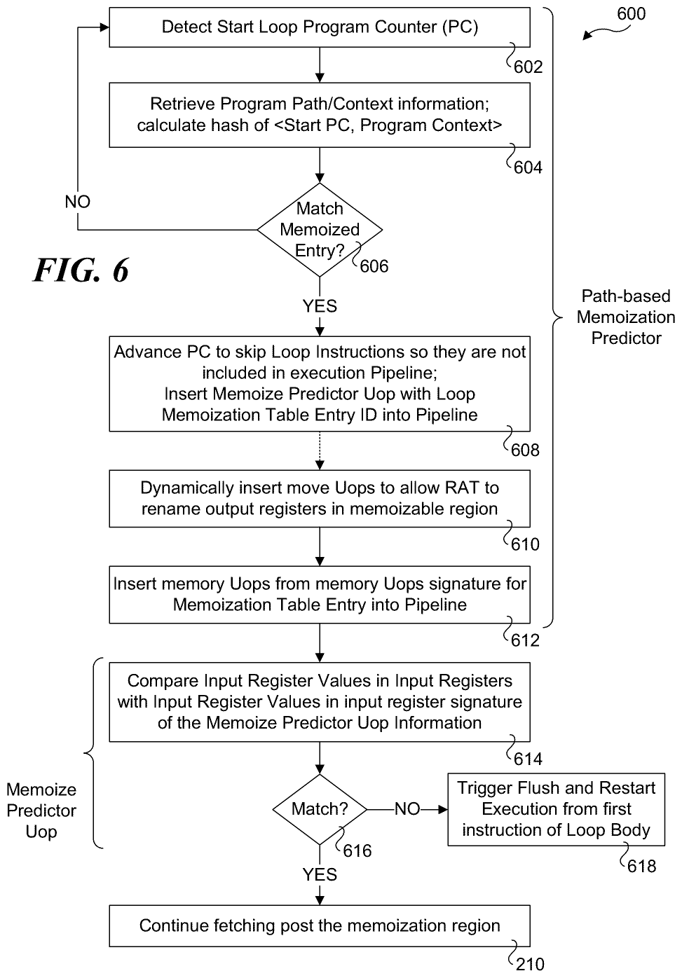

FIG. 6 shows a flowchart 600 illustrating operations performed by path-based memoization predictor 310 and execution of the memoize predictor Uop, according to one embodiment. The flow begins in a block 602 in which a start loop PC is detected. At this stage, the start loop PC may or may not correspond to a memoized loop for corresponding entries 402 in loop memoization table 308 and entries 502 maintained by path-based memoization predictor 310. To predict whether the start loop PC corresponds to a memoized loop, the memoization predictor retrieves program path/context information 317 and calculates a hash of <Start (loop) PC, Program Context> to see if it matches one of its memoization predictor table entries.

In a decision block 606 a determination is made to whether the hash matches a tag 504 for an entry 502 in memoization predictor table 500. If it does not, the answer to decision block 606 is NO and the logic returns to block 602 to detect a next start loop PC in the pre-execution instruction pipeline.

A tag match indicates a corresponding entry 402 in loop memoizable table 308 exists and the memoization predictor predicts the loop entering the pipeline is a memoized loop. As shown by a YES result for decision block 606, when there is a tag match the logic proceeds to a block 608 in which the loop instructions are removed from the instruction pipeline. In one embodiment, this is accomplished by advancing the PC to the end of the loop such that the loop instructions are skipped. The memoization predictor also inserts a memoize predictor Uop into the instruction pipeline with the memoization table loop instance ID, which is used to identify a corresponding entry in loop memoization table 308.

In a block 610, move Uops are dynamically inserted into the instruction pipeline to allow RAT 108 to rename output registers in the memoizable region (i.e., the predicted instance of the memoized loop). The move Uops are generated using output register signature 320. The output register signature is a sequence like OReg1:Value1, OReg2:Value2 . . . ORegn:Valuen. For example, for Uops RAX:0x4, RBX,0x8 the corresponding move Uops are inserted into the pipeline as Mov RAX, $0x4 and Mov RBX. In a block 612 the memory Uops from memory Uops signature 414 are inserted into the pipeline using the stored sequence and order.

Subsequently, the instructions in the pipeline are forwarded for scheduling by RS 118. RS 118 readies instruction Uops for execution by execution unit 302, which executes the Uops except for memoize predictor Uop 316, which is not executed. Following execution of the Uops, the completed Uops are monitored for memoize predictor Uop 316. Upon detection of an instance of the memoize predictor Uop, the operation shown in block 614, decision block 616 and (if applicable) block, are performed.

In block 614 the input register values in the input registers for the core are compared to the input register values (i.e., input reg signature 318) in memoize predictor Uop information field 412. If there is a match, as determined in decision block 616, the loop for which the memoization prediction was made is a memoized loop. Accordingly, the answer is YES and execution of the instruction pipeline continues by fetching instructions following the memoization region in a block 210, which performs similar operations to that described for block 210 in FIG. 2.

If decision block 616 determines there is not a match, this indicates that the loop for which the memoization prediction was made is not a memoized loop. In this (NO) case, the logic proceeds to block 618, which triggers a flush of the pipeline and restarts execution of the instructions from the first instruction in the loop body. This is similar to how a misprediction of a branch is handled by the BPU. The loop instructions are read from the instruction cache and added to the execution pipeline.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

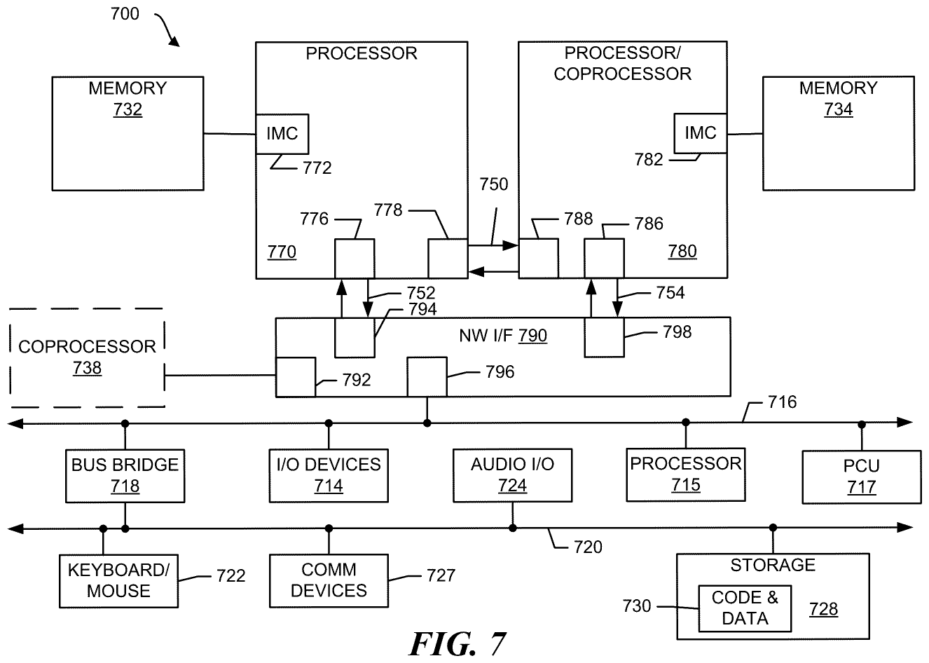

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

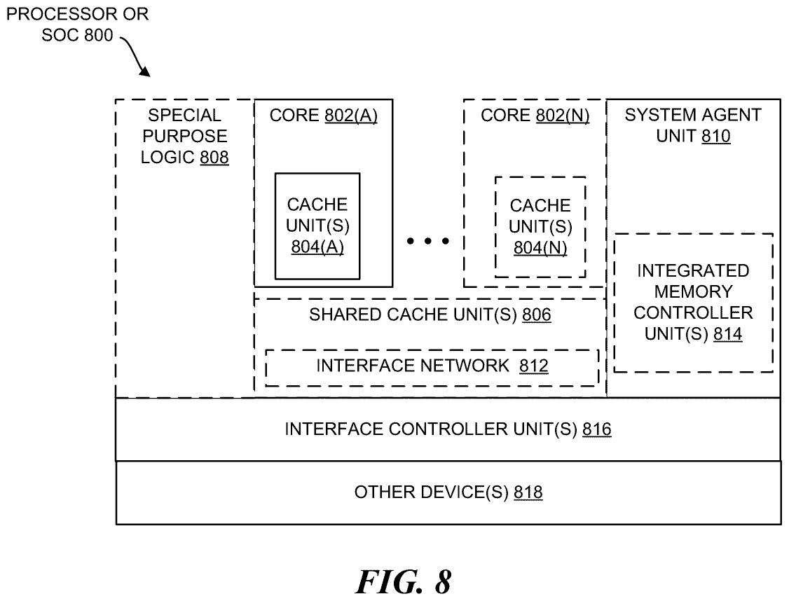

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Core Architectures—In-Order and Out-of-Order Core Block Diagram

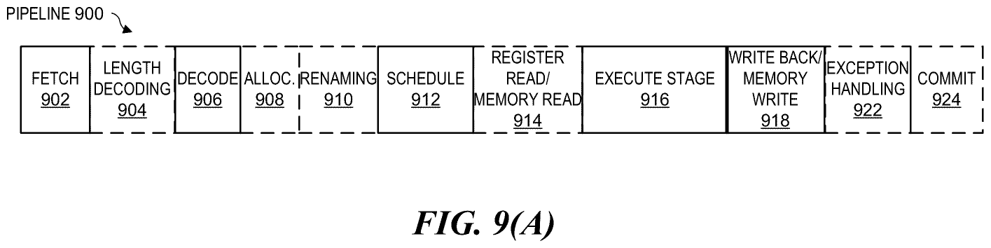

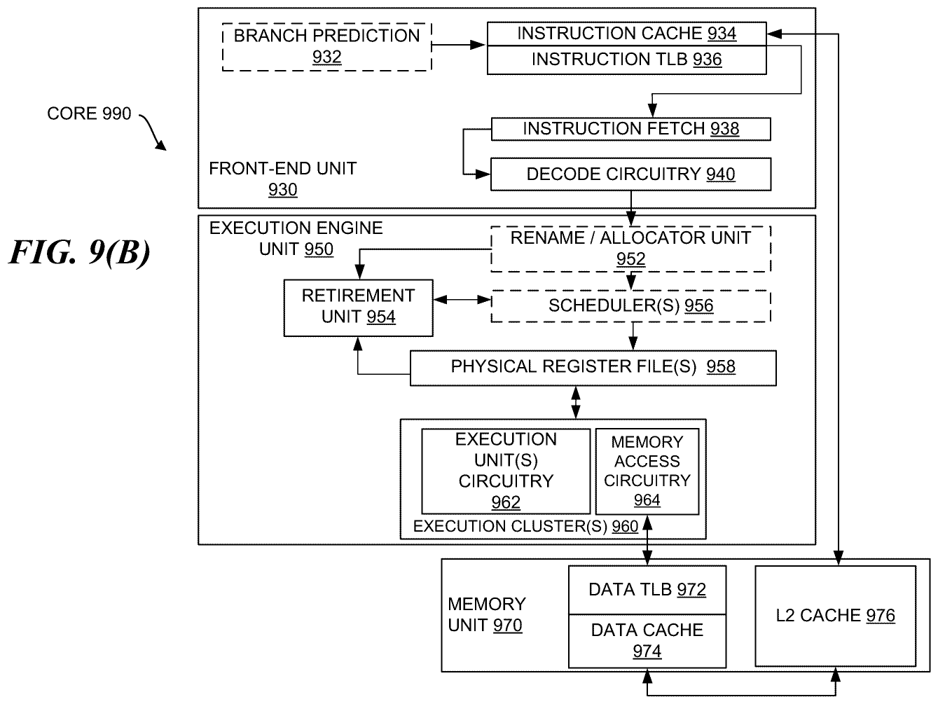

FIG. 9(A) is a block diagram illustrating both an example in-order pipeline and an example register renaming, out-of-order issue/execution pipeline according to examples. FIG. 9(B) is a block diagram illustrating both an example in-order architecture core and an example register renaming, out-of-order issue/execution architecture core to be included in a processor according to examples. The solid lined boxes in FIGS. 9(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9(A), a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 9(B) may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9(B) shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front-end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In one example, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Example Execution Unit(s) Circuitry

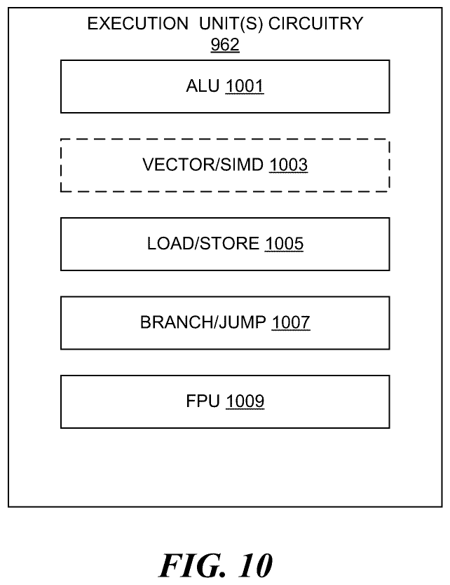

FIG. 10 illustrates examples of execution unit(s) circuitry, such as execution unit(s) circuitry 962 of FIG. 9(B). As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

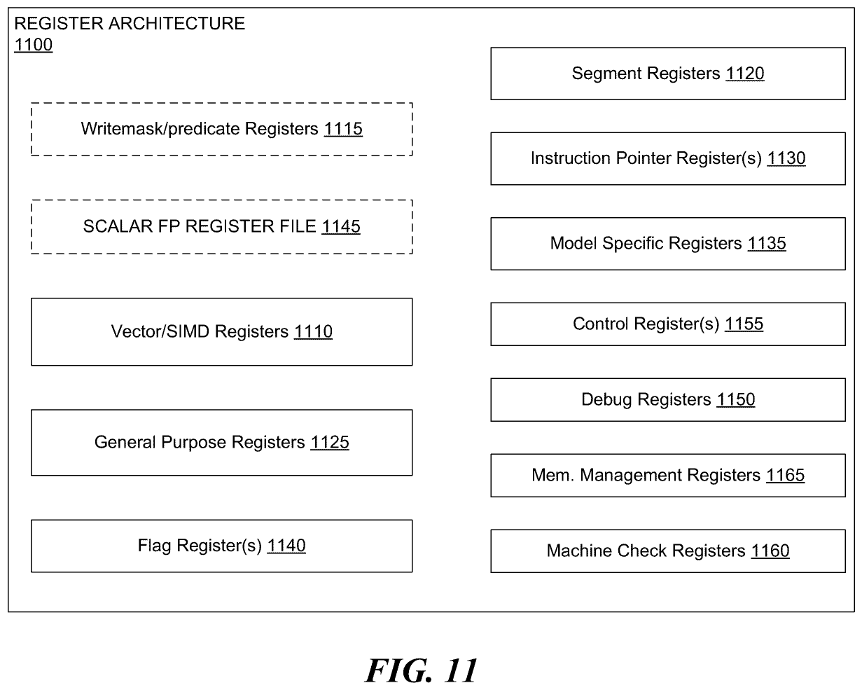

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register file 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Model specific registers (MSRs) 1135 are a type of control register that control and report on processor performance for a given processor model or family. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1100 may, for example, be used in a register file/memory, or physical register file(s) circuitry 958.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘M’, ‘N, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus comprising:
one or more processor cores configured to execute instructions; and
hardware-based logic to,
detect loops in sequences of instructions;
memoize one or more loops that are repeated during execution of the one or more instruction sequences;
predict an instance of a loop in an instruction sequence is a memoized loop; and
for the predicted instance of the memoized loop,
remove instructions in the predicted instance of the memoized loop from the instruction sequence;
determine input data loaded into input registers at a start of the loop are the same as in previous instances of the memoized loop; and
when the input data are the same, continue execution of instructions in the instruction sequence.

2. The apparatus of claim 1, wherein the hardware-based logic is further configured to:
store an output context for the memoized loop comprising output register values upon completion of the loop and memory loads and/or stores performed via execution of the memoized loop; and
reproduce the output context of the memoized loop as if the instructions in the memoized loop had been executed.

3. The apparatus of claim 1, wherein the apparatus further comprises:
a loop memoization table configured to store a plurality of entries, each entry containing information pertaining to a respective memoized loop including,
a loop start program counter (PC);
an input register signature comprising a set of input register values when the loop begins; and
an output register signature comprising a set of output register values when the loop is completed.

4. The apparatus of claim 3, wherein the hardware-based logic is further configured to:
insert a memoization predictor micro-op (Uop) into the instruction sequence to track an input register signature for the predicted instance of the memoized loop;
compare the input register signature associated with the memoization predictor Uop with register input values loaded in input registers in preparation for execution of a first instruction in the loop; and
when the input register values in the input register signature match the input values that are loaded, continue execution of instructions in the instruction sequence.

5. The apparatus of claim 4, wherein the hardware-based logic is further configured to remove the memoization predictor Uop from the instruction sequence.

6. The apparatus of claim 4, wherein the hardware-based logic is further configured to flush a portion of the instructions and restart execution of the sequence of instructions including the loop instructions when the input register values in the input register signature do not match the loaded input register values.

7. The apparatus of claim 1, further comprising a post retirement Uop buffer, wherein the hardware-based logic is further configured to:
write retired Uops to the post retirement Uop buffer;
inspect retired Uops in the post-retirement Uop buffer to identify loops that are repeated; and
identify repeated loops that are candidates for memoization.

8. The apparatus of claim 7, wherein the loops are identified as being repeated, at least in part, by tracking back branch program counters.

9. The apparatus of claim 1, further comprising a memoize context buffer that is used to track input and output values through registers and loads/stores and an order in which they occur when a memoized loop is executed.

10. A method implemented in hardware of an apparatus including one or more processor cores configured to execute instructions, comprising:
memoizing one or more loops that are repeated during execution of instruction sequences;
predicting an instance of a loop in an instruction sequence is a memoized loop; and
for the predicted instance of the loop,
determining input data loaded into input registers at a start of the loop are the same as in previous instances of the memoized loop; and
when the input data are the same, eliminate instructions in an instance of the memoized loop from the instruction sequence.

11. The method of claim 10, further comprising:
storing an output context for the memoized loop comprising output register values upon completion of the loop and memory loads and/or stores performed via execution of the memoized loop; and
restoring the output context of the memoized loop as if the instructions in the memoized loop had been executed.

12. The method of claim 10, further comprising:
storing a plurality of entries in a loop memoization table, each entry containing information pertaining to a respective loop that has been memoized including,
a loop start program counter (PC);
an input register signature comprising a set of input register values when the loop begins; and
an output register signature comprising a set of output register values when the loop is completed.

13. The method of claim 12, further comprising:
inserting a memoization predictor micro-op (Uop) into the instruction sequence to track an input register signature for the predicted instance of the memoized loop;
comparing the input register signature associated with the memoization predictor Uop with register input values loaded in input registers in preparation for execution of a first instruction in the loop; and
when the input register values in the input register signature match the input values that are loaded, skipping execution of instructions in the instance of the loop.

14. The apparatus of claim 13, wherein loop instructions are removed from the instruction sequence prior to comparing the input register signature with the register input values.

15. The method of claim 13, further comprising flushing a portion of the instruction sequence and restarting execution of an instruction sequence including the loop instructions when the input register values in the input register signature do not match the loaded input register values.

16. The apparatus of claim 10, further comprising a post retirement Uop buffer, and wherein the hardware-based logic is further configured to:
writing retired Uops to a buffer;
inspecting retired Uops in the buffer to identify loops that are repeated; and
identify repeated loops that are candidates for memoization.

17. A computing system, comprising:
memory;
instructions, stored in the memory, including sequences of instructions; and
a processor, coupled to the memory, including one or more processor cores configured to execute the instructions and having hardware-based logic configured to,
memoize one or more loops that are repeated during execution of one or more instruction sequences;
predict an instance of a loop in an instruction sequence is a memoized loop; and
for the predicted instance of the memoized loop,
remove instructions in the predicted instance of the memoized loop from an instruction sequence;
determine input data loaded into input registers at a start of the loop are the same as in previous instances of the memoized loop; and
when the input data are the same, continue execution of instructions in the instruction sequence.

18. The computer system of claim 17, wherein the hardware logic is further configured to:
track memoize context information including input and output values through registers and loads/stores and an order in which they occur when a memoized loop is executed, and
reproduce the memoized context information for the predicted memoized loop as if the instructions in the predicted memoized loop had been executed.

19. The computer system of claim 17, wherein the processor further comprises:
a loop memoization table configured to store a plurality of entries, each entry containing information pertaining to a respective memoized loop including,
a loop start program counter (PC);
an input register signature comprising a set of input register values when the loop begins; and
an output register signature comprising a set of output register values when the loop is completed.

20. The system of claim 19, wherein the hardware-based logic is further configured to:
insert a memoization predictor micro-op (Uop) into the instruction sequence to track an input register signature for the predicted instance of the memoized loop;
compare the input register signature associated with the memoization predictor Uop with register input values loaded in input registers in preparation for execution of a first instruction in the loop; and
when the input register values in the input register signature match the input values that are loaded, skip execution of instructions in the instance of the loop.
